(19) United States
(12) Patent Application Publication
(10) Pub. No.: US 2011/0134336 A1
(43) Pub. Date: Jun. 9, 2011

(54) DIGITAL MULTIMEDIA BROADCASTING SYSTEM FOR REDUCING SCAN TIME, AND METHOD FOR THE SAME

(75) Inventors: Sang Ki KIM, Hwaseong (KR); Suk Young ROH, Hwaseong (KR); Don Hyoung LEE, Anyang (KR); Ryuk KIM, Hwaseong (KR); Jeong Hwan HWANG, Suwon (KR); Jeong-Won YOON, Seoul (KR)

(73) Assignees: HYUNDAI MOTOR COMPANY, Seoul (KR); KIA MOTORS CORPORATION, Seoul (KR); C&S TECHNOLOGY CO., LTD., Seoul (KR)

(21) Appl. No.: 12/784,771

(22) Filed: May 21, 2010

(30) Foreign Application Priority Data
Dec. 4, 2009 (KR) 10-2009-0120168

(51) Int. Cl. H04N 5/50

(52) U.S. Cl. 348/731; 348/E05.097

(57) ABSTRACT

The present invention features a DMB System for reducing scan time, and a method for the same, wherein, the DBM system comprises a DMB receiving unit and a TPEG-only receiving unit, and is able to reducing scan time for total channels by performing a scanning process for total channels together by the DMB receiving unit and the TPEG-only receiving unit, respectively.

### CROSS-REFERENCE TO RELATED APPLICATION

The present application claims under 35 U.S.C. §119(a) priority to Korean Patent Application Number 10-2009-0120168, filed on Dec. 4, 2009, the entire contents of which are incorporated herein for all purposes by this reference.

### BACKGROUND OF THE INVENTION

1. Field of the invention

The present invention relates, generally, to a Digital multimedia broadcasting (DMB) system, and more particularly, to a DMB system for reducing scan time, wherein, in the DMB system including a DMB receiver and a TPEG (Transport Protocol Expert Group)-only receiver, it is possible to suitably reduce scan time for total channels, and method for the same.

2. Description of Background Art

In general, an EUREKA-147 system that is used in a digital multimedia broadcasting (DMB) system, has a structure which may transmit service modulated by a digital modulation method and service components that use only a frequency, while the AM/FM broadcasting transmits a broadcasting signal using only a frequency.

An ensemble structure of the EUREKA-147 system (Here, the ensemble means a bundle of audio services and data services which are transmitted in the case of selecting a broadcasting frequency) may preferably include a FIC (Fast Information Channel) and actual audio services, wherein the FIC is composed of a FIB (Fast Information Block) including various information in relation to services and a FIG (Fast Information Group) as a substructure of the FIB. The ensemble structure may be formed by a Main Service Channel (MSC) composed of a bundle of Sub-Channels.

Such a terrestrial DMB signal is composed of ensemble units, and one ensemble is composed of various services. Also, each of the services preferably includes several service components. That is, one ensemble is a basic element for constituting the terrestrial DMB signal, and a user may preferably listen to a specific service by selecting a service in the ensemble. Commonly, a plurality of video services, audio services and data services may be included in one ensemble.

In addition, the ensemble, the service and the service components of the EUREKA-147 system is generally retrieved by a frequency auto-scan method which is similar to the AM/FM broadcasting. Further, the EUREKA-147 system allows a listener to listen the requested broadcasting by using the information retrieved by a DMB receiver.

FIG. 1 is a block diagram of a DMB system described in the prior art. FIG. 2 illustrates an exemplary scan method of a DMB system according to the prior art.

Referring to FIG. 1, a DMB system according to the prior art comprises an antenna 10, a DMB receiving unit 20, an A/V decoder 30, a memory 40, an LCD 50 and a speaker 60. Here, the DMB receiving unit 20 may preferably include a radio frequency (RF) tuner 21 and a channel decoder 22, where the A/V decoder 30 includes a modem data processing unit 31.

Preferably, the RF tuner 21 of the DMB receiving unit 20 performs frequency tuning by each of frequency bands for a DMB signal which is suitably received through the antenna 10. The channel decoder 22 decides, through a lock status check process by the RF tuner 21, whether the DMB signal of a broadcasting signal is received or not and collects fast information channel (FIC) data when the broadcasting signal is received.

The modem data processing unit 31 of the A/V decoder 30 collects the FIC data for a given period of time, and decides whether the FIC data have suitably normal information for the corresponding channel or not. Further, if it is decided that the information is normal ensemble channel information according to a result of the decision, the modem data processing unit 31 stores the normal ensemble information of the corresponding frequency band into the memory 50. Subsequently, video data and audio data which are decoded by the A/V decoder 40 are outputted through the LCD 50 and the speaker 60.

Referring to FIG. 2, in an exemplary DMB system, the frequency auto-scanning process may suitably perform frequency scan by scanning a frequency table by each of the frequency bands in a scan direction which is given by the RF tuner 21, and collect the FIC information in a case where a lock status check is complete. Preferably, the frequency auto-scanning process may analyze the collected FIC information and acquire normal channel information. The above-described scanning process for channel retrieval is repeatedly performed up to the final frequency band.

A DMB system that has been previously described performs the channel retrieval using only an RF tuner 21, and the time for the lock status check of the RF tuner 21 is even faster than the time for collecting the FIC information. Accordingly, it takes a relatively long time for the retrieval of all the channels because the system must wait for a certain time while the process is being performed for the FIC information to be collected in relation to one channel.

DMB receivers for broadcasting both broadcasting signal and traffic information that have been described by the prior art must individually form the MPEG tuner and the TPEG tuner, and as a result must perform scanning and decoding the broadcasting signal for a given scan time.

Accordingly, there remains a need in the art for improved DMB systems for reducing scan times.

The above information disclosed in this the Background section is only for enhancement of understanding of the background of the invention and therefore it may contain information that does not form the prior art that is already known in this country to a person of ordinary skill in the art.

### BRIEF SUMMARY OF THE INVENTION

The present invention features a DMB system for reducing scan time, and method for the same, wherein, the DBM system having a DMB receiving unit and a TPEG-only receiving unit, is able to suitably reduce scan time for total channels by performing scanning process for all of the channels together by the DMB receiving unit and the TPEG-only receiving unit, respectively.

In a preferred embodiment of the present invention, the DMB system for reducing scan time, may preferably include a first broadcasting receiving unit for receiving a DMB signal of the first broadcasting data, suitably performing frequency tuning for the DMB signal by each of frequency bands, suitably deciding whether the DMB signal is received or not, preferably through a lock status check, and collecting fast information channel (FIC) data if the DMB signal is suitably received; a second broadcasting receiving unit for suitably receiving second broadcasting data, suitably performing frequency tuning for a broadcasting signal of the second broadcasting data by each of frequency bands, deciding whether the broadcasting signal is suitably received or not, through a lock status check, and collecting fast information channel (FIC) data if the broadcasting signal is suitably received; an A/V (Audio/Video) decoder for collecting the FIC data for a given period of time, deciding whether the FIC data have normal information for the corresponding channel or not, and storing ensemble channel information of the corresponding frequency band into a memory when the information is normal ensemble channel information according to a result of the decision, wherein, the first and second broadcasting receiving units performs frequency tuning for a list of total frequencies in a first scan direction and a second scan direction at the same time.

In a preferred embodiment, the first broadcasting receiving unit is a DMB receiving unit, and the second broadcasting receiving unit is a TPEG (Transport Protocol Expert Group)-only receiving unit, wherein the second broadcasting data which are received by the TPEG-only receiving unit are TPEG data.

In another preferred embodiment of the present invention, during the FIC data collecting process using any one receiving unit of the first and second broadcasting receiving units, in which a relatively long time is required, a lock status check process by the RF tuners or a FIC data collecting process is suitably performed in parallel using other receiving unit at the same time.

Preferably, in certain embodiments, the DMB receiving unit may include a first RF tuner for performing frequency tuning for the DMB signal which is received through a first antenna by each of frequency bands in the first scan direction; and a first channel decoder for suitably deciding, through the lock status check of the first RF tuner, whether the broadcasting signal is suitably received or not, and for collecting the FIC data if it is decided that the broadcasting signal is received.

According to further preferred embodiments, the TPEG-only receiving unit may include a second RF tuner for performing frequency tuning for the TPEG signal which is received through a second antenna by each of frequency bands in the second scan direction; and a second channel decoder for deciding, through the lock status check of the second RF tuner, whether the broadcasting signal is suitably received or not, and for collecting the FIC data if it is decided that the broadcasting signal is suitably received.

In another preferred embodiment of the present invention, when the collecting process of information for the corresponding channel and the storing process of information for an Ensemble channel are suitably completed, the first and second broadcasting receiving units select any one of frequencies which are not yet dealt in the list of total frequencies, and then, suitably perform a channel retrieval scan process, respectively.

In another preferred embodiment of the present invention, the channel retrieval scanning process is programmed to be repeatedly performed up to the final frequency band.

Preferably, the first and second scan directions are in the reciprocally opposite direction on a frequency table.

According to other further embodiments, the A/V decoder may include a first modem data processing unit and a second modem data processing unit which are suitably allocated to each of the first and second broadcasting receiving units, wherein the first and second modem data processing units collect the FIC data for a given period of time, respectively, and then, when the FIC data are sufficiently collected in the given period of time, they decide whether the FIC data have normal information for the channel or not.

In another preferred embodiment of the present invention, a method for reducing scan time in a DMB system including a first broadcasting receiving unit and a second broadcasting receiving unit, may preferably include the steps of: a) starting to collect channel information for a first frequency in a list of total frequencies using the first broadcasting receiving unit, and, starting simultaneously to collect channel information for a second frequency using the second broadcasting receiving unit; b) suitably deciding, through a lock status check of the RF tuner, whether a broadcasting signal is suitably received or not, which is performed by the first and second broadcasting receiving units, respectively, and collecting to transmit the FIC data to an A/V decoder when the broadcasting signal is received; c) suitably collecting the FIC data for a given period of time, which is performed by each of first and second modem data processing units allocated to each of receiving units in the A/V decoder, and deciding whether the FIC data have normal information for the corresponding channel or not; d) suitably storing normal ensemble channel information of the corresponding frequency band into a memory if the FIC data have normal ensemble channel information according to a result of the decision; and e) suitably selecting any one frequency are not yet dealt in the list of total frequencies, which is performed by the first and second broadcasting receiving units, respectively, and performing a channel scan process, when both of the correcting process of information for the corresponding channel and the storing process of the ensemble channel information are completed.

Preferably, in step a), the first broadcasting receiving unit is preferably a DMB receiving unit, and the second broadcasting receiving unit is preferably a TPEG (Transport Protocol Expert Group)-only receiving unit.

In another preferred embodiment of the present invention, the channel scanning process from step a) to step e) is suitably programmed to be repeatedly performed up to the final frequency band.

In step a), the first and second broadcasting receiving units performs frequency tuning for the list of total frequencies in a first scan direction and a second scan direction at the same time, in which the first and second scan direction are in the reciprocally opposite direction on a frequency table.

In step a), during the FIC data collecting process using any one receiving unit of the first and second broadcasting receiving units, in which a relatively long time is required, a lock status check process by the RF tuners or a FIC data collecting process is suitably performed in parallel using other receiving units at the same time.

According to the present invention, the DBM system which has a DMB receiving unit and a TPEG-only receiving unit, is able to suitably reduce scan time for total channels by performing scanning process for total channels in common by the DMB receiving unit and the TPEG-only receiving unit, respectively. For example, in a case where the DMB receiving unit and the TPEG-only receiving unit are provided, a lock status check process by the RF tuners or a FIC data collecting process may be suitably performed in parallel using other receiving units at the same time, during the FIC data collecting process using any one receiving unit of the first and second broadcasting receiving units without adding additional cost, in which a relatively long time is required. And accordingly, it is possible to suitably reduce the scan time for total channels to the extent of the half and improve a scan speed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a block diagram of a DMB system according to the prior art.

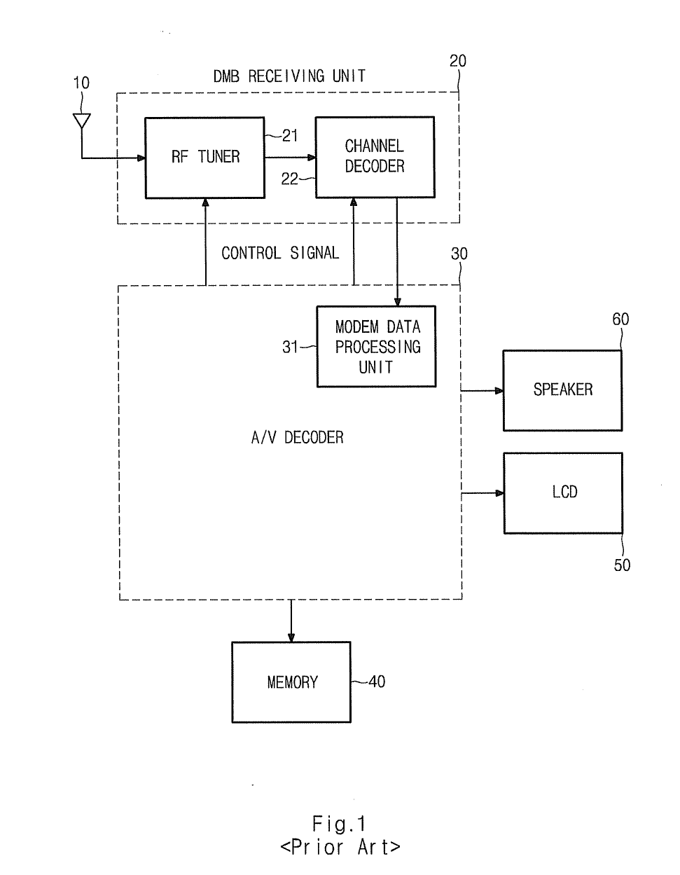

FIG. 2 is a view for explaining a scan method of a DMB system according to the prior art.

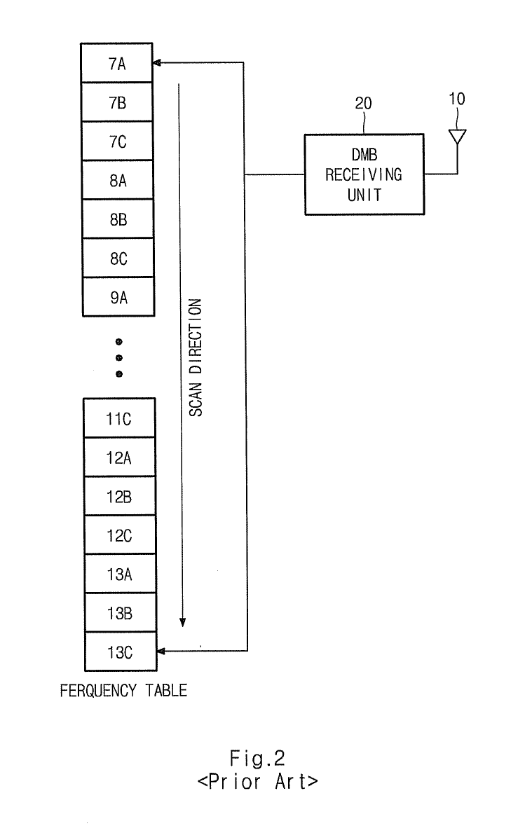

FIG. 3 is a block diagram for illustrating a structure of DMB terminal able to receiving a DMB signal according to the prior art.

FIG. 4 is a view for explaining a structure of a DMB receiver for broadcasting both broadcasting signal and traffic information according to the prior art.

FIG. 5 is a block diagram of DMB system for reducing scan time according to an embodiment of the present invention.

FIG. 6 is a view for explaining a method for reducing scan time of a DMB system according to an embodiment of the present invention.

FIG. 7 is a flow chart of a method for reducing scan time by a DMB receiving unit in a DMB system according to an embodiment of the present invention.

FIG. 8 is a flow chart of a method for reducing scan time by a TPEG-only receiving unit in a DMB system according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE PREFERRED EMBODIMENTS

The present invention features digital multimedia broadcasting (DMB) systems for reducing scan times. In a first aspect, the invention features a DMB system for reducing scan time, the DMB system comprising a first broadcasting receiving unit for receiving a DMB signal of the first broadcasting data, a second broadcasting receiving unit for receiving a second broadcasting data, and an A/V (Audio/Video) decoder, wherein, the first and second broadcasting receiving units performs frequency tuning for a list of total frequencies in a first scan direction and a second scan direction at the same time.

In one embodiment, the first broadcasting unit receives a DMB signal from the first broadcasting data, performs frequency tuning for the DMB signal by each of frequency bands, decides whether the DMB signal is received or not, through a lock status check, and collects fast information channel (FIC) data if the DMB signal is received.

In another embodiment, the second broadcasting receiving unit receives second broadcasting data, performs frequency tuning for a broadcasting signal of the second broadcasting data by each of frequency bands, decides whether the broadcasting signal is received or not, through a lock status check, and collects fast information channel (FIC) data if the broadcasting signal is received.

In another further embodiment, the A/V decoder collects the FIC data for a given period of time, decides whether the FIC data has normal information for the corresponding channel or not, and stores ensemble channel information of the corresponding frequency band into a memory when the information is normal ensemble channel information according to a result of the decision.

In another aspect, the present invention features a method for reducing scan time in a DMB system including a first broadcasting receiving unit and a second broadcasting receiving unit, the method comprising the steps of a) starting to collect channel information for a first frequency in a list of total frequencies using the first broadcasting receiving unit, and, starting simultaneously to collect channel information for a second frequency using the second broadcasting receiving unit, b) deciding, through a lock status check of the RF tuner, whether a broadcasting signal is received or not, which is performed by the first and second broadcasting receiving units, respectively, and collecting to transmit the FIC data to an A/V decoder when the broadcasting signal is received, c) collecting the FIC data for a given period of time, which is performed by each of first and second modem data processing units allocated to each of receiving units in the A/V decoder, and deciding whether the FIC data have normal information for the corresponding channel or not, d) storing normal ensemble channel information of the corresponding frequency band into a memory if the FIC data have normal ensemble channel information according to a result of the decision; and e) selecting any one frequency are not yet dealt in the list of total frequencies, which is performed by the first and second broadcasting receiving units, respectively, and performing a channel scan process, when both of the correcting process of information for the corresponding channel and the storing process of the ensemble channel information are completed.

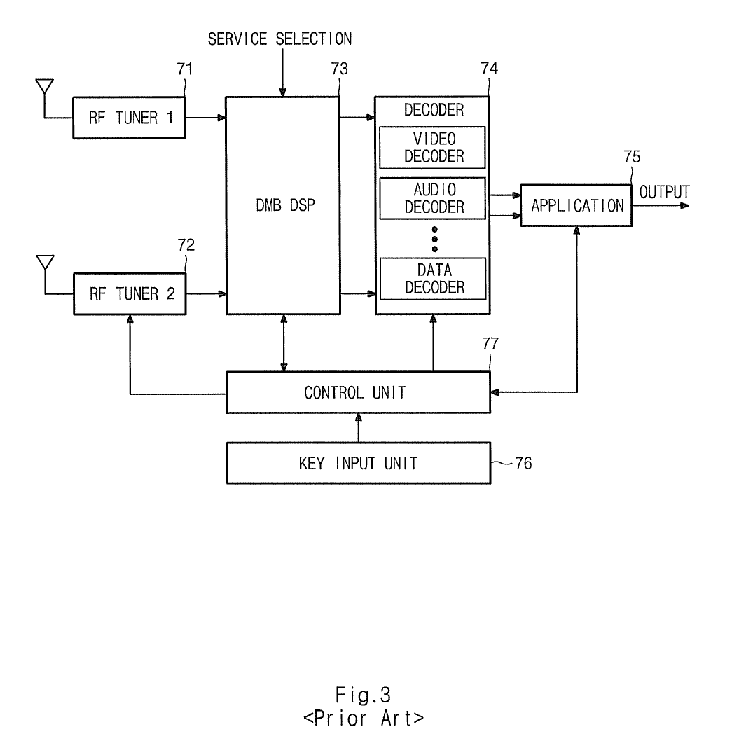

Korean Patent Number 10-0810238 (Filing date: 12 Aug. 2005), incorporated by reference in its entirety herein, provides “DMB TERMINAL FOR IMPROVING THE RECEIVING FUNCTION USING DUAL TUNER IN A TERRESTRIAL DMB SYSTEM AND IT'S CONTROLLING METHOD”, and is explained with reference to FIG. 3.

FIG. 3 is a block diagram for illustrating a structure of a DMB terminal able to receiving a DMB signal according to the prior art.

Referring to FIG. 3, the DMB terminal able to receiving a DMB signal according to the prior art, may preferably include a first RF tuner 71, a second RF tuner 72, a DMP DSP 73, a decoder 74, an application 75, a key input unit 76 and a control unit 77.

The first RF tuner 71 preferably receives an ensemble of the terrestrial DMB system which is selected by a user, and the second RF tuner 72 receives the ensemble which is receiving by the first RF tuner 71 or an ensemble which is transmitted using a different frequency in order to provide the user with additional services.

Preferably, the DMB DSP 73 performs a signal processing for the ensembles which are received by the first RF tuner 71 and the second RF tuner 72, and performs filtering and transmitting the service component for constituting the service which is selected by the user. The decoder 74 receives the service components 74 transmitted from DMB DSP 73, and performs decoding the received service components into data in a form to be outputted and transmitting the decoded data.

The application 75 receives the decoded data from the decoder 74, and outputs data in a form to be requested by the user.

The key input unit 76 inputs keys for selecting or operating functions which are supported by the DMB terminal, and the control unit 77 controls overall operations of the DMB terminals on the basis of the established additional services and the user inputs.

Accordingly, since the DMB terminal able to receiving a DMB signal according to the prior art applies two tuners to the conventional DMB terminal, it may provide additional services for receiving and scanning service of an ensemble of a different frequency band using another tuner even if one tuner is being used.

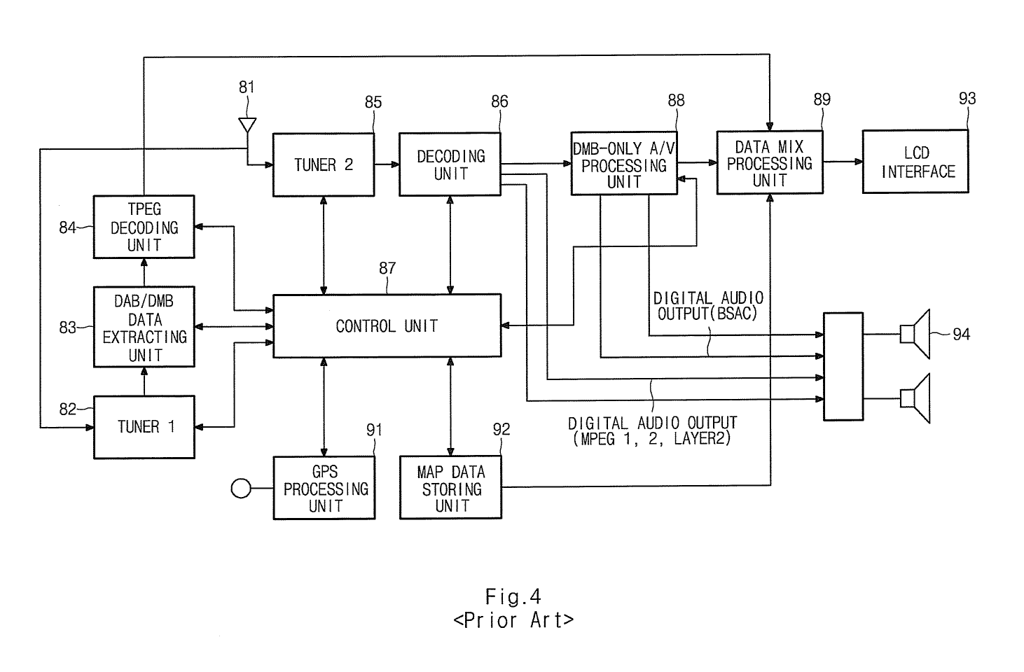

Korean Patent Number 10-0777684 (Filing date: 19 Aug. 2005) provides “DIGITAL MULTI-MEDIA BROADCASTING RECEIVING APPARATUS AND PROCESSING METHOD THEREOF”, incorporated by reference in its entirety herein, is explained with reference to FIG. 4.

FIG. 4 is a view for explaining a structure of a DMB receiver for broadcasting both broadcasting signal and traffic information according to the prior art.

Referring to FIG. 4, the DMB receiver for broadcasting both broadcasting signal and traffic information according to the prior art may preferably include an antenna 81 for receiving a DMB signal; first and second tuner 82, 85 for scanning and filtering the specific channel for the DMB signal which is received through the antenna 81 and performing under the control of the control unit 87; a DAB/DMB data extracting unit 83 for extracting DAB/DMB data among signals provided by the first tuner 82 under the control of the control unit 87; a TPEG decoder 84 for decoding only traffic information data among the DAB/DMB data extracted by the DAB/DMB data extracting unit 83 on the basis of the control signal provided by the control unit 87, and outputting the decoded traffic information data; the decoder 86 for performing channel decoding for the DMB signal provided by the second tuner 85, and then performing audio decoding and data decoding; a DMB-only A/V processing unit 88 which encodes the decoded data provided by the decoder 86 into MPEG-4 or decides whether inputted moving picture data are data of the MPEG-4 form or data of H.264 AVC Baseline form, decodes the moving picture data and outputs the decoded moving picture data through an LCD interface 93, or which encodes the decoded digital audio data and outputs the encoded digital audio data through a speaker 94; a TPEG decoder 84 for decoding only traffic information data among the decoding data provided by the decoder 86, and outputting the decoded traffic information data; a data mix processing unit 89 for mixing an image signal provided by the DMB-only A/V processing unit 88 with a traffic information signal provided by the TPEG decoder 84 on the basis of a control signal provided by the control unit 87, and outputting the mixed signal through the LCD interface 93; a Map data storing unit 92 for storing map data, and outputting the map data to the data mix processing unit 89 on the basis of a control signal provided by the control unit 87; a GPS processing unit 91 for providing a value of a present position in order to display the present position on the map data on the basis of a control signal provided by the control unit 87; and the control unit 87 for controlling overall of the system.

Preferably, the DMB receiver for broadcasting both broadcasting signal and traffic information according to the prior art may receive the moving picture or the audio signal in a specific ensemble in which the traffic information is not included, or may receive the traffic information which is provided by another ensemble, and output the traffic information on the side of a display in which the moving picture or the audio signal are being outputted. And accordingly, it is possible to broadcast both the broadcasting signal and the traffic information.

With reference to the accompanying drawings, reference will now be made in detail to exemplary embodiments of the present invention so that those skilled in the art may embody easily. But, the present invention may be embodied in various embodiments, which are not limited by the embodiments illustrated herein. In the accompanying drawings, some elements regardless of the description of the present invention are omitted in order to describe the present invention clearly, and, like reference numerals refer to the like elements throughout.

As used herein, if a certain component “comprises” or “includes” a certain element, it means that the component may additionally include other elements not to exclude the other element unless otherwise specifically defined. In addition, the terms “component” and “unit” described in this specification are intended to refer to a unit for processing at least a function or an operation, and it may be embodied by either hardware, software or a combination of hardware and software.

In preferred embodiments of the present invention, a DMB system for reducing scan time, and method for the same are provided, wherein, by using both of an RF tuner for a conventional DMB receiver and an RF tuner for TPEG-only receiver in collecting information for total channels of a DMB system, it is able to reducing scan time for total channels by performing scanning process for another channel at the same time during a process for collecting FIC data for the corresponding scan channel.

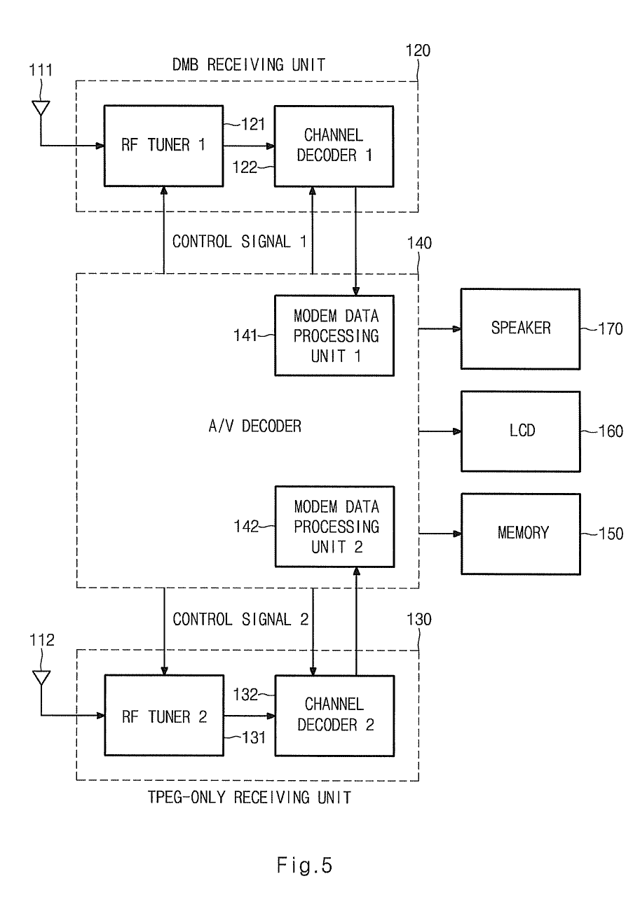

According to certain preferred embodiments and as shown in FIG. 5, FIG. 5 is a block diagram of a DMB system for suitably reducing scan time.

Referring to FIG. 5, the DMB system for reducing scan time according to exemplary embodiments of the present invention may preferably include antennas 111 and 112, a DMB receiving unit 120, a TPEG-only receiving unit 130, an A/V decoder 140, a memory 150, an LCD 160 and a speaker 170. Preferably, the DMB receiving unit 120 may include a first RF tuner 121 and a first channel decoder 122, and the TPEG-only receiving unit 130 may preferably include a second RF tuner 131 and a second channel decoder 132. In further preferred embodiments, the A/V decoder 140 may include a first modem data processing unit 141 and a second modem data processing unit 142.

Here, it will be apparent to those of ordinary skill in the art that, although the DMB receiving unit 120 may be a first broadcasting receiving unit, and the TPEG-only receiving unit 130 may be a second broadcasting receiving unit in the embodiment of the present invention, they are not to be limited. Accordingly, the first broadcasting receiving unit and the second broadcasting receiving unit are not to be limited to the DMB receiving unit 120 and the TPEG-only receiving unit 130.

According to certain preferred embodiments, the DMB receiving unit 120 performs the frequency tuning for total frequencies in order to suitably acquire the receivable channel information, and transmits the broadcasting data of the allocated channel into the A/V decoder 140 for performing the audio/video decoding.

Preferably, the TPEG-only receiving unit 130 receives TPEG data from a channel in which TPEG information is in existence, and transmits the TPEG data into the A/V decoder 140 in order to acquire valid data.

Preferably, the first RF tuner 121 of the DMB receiving unit 120 performs frequency tuning for the DMB signal which is suitably received through a first antenna 111 by each of frequency bands, and the first channel decoder 122 decides, through the lock status check of the first RF tuner 121 whether the broadcasting signal is suitably received or not, and collects the FIC data if it is decided that the broadcasting signal is suitably received.

According to further preferred embodiments, the second RF tuner 131 of the TPEG-only receiving unit 130 performs frequency tuning for the TPEG signal which is received through a second antenna 112 by each of frequency bands, and the second channel decoder 132 decides, through the lock status check of the second RF tuner 131, whether the broadcasting signal is suitably received or not, and for collecting the FIC data if it is decided that the broadcasting signal is suitably received.

Preferably, the first and second modem data processing unit 141 and 142 of the A/V decoder 140 may collect the FIC data for a given period of time, and decide whether the FIC data have normal information for the corresponding channel or not, respectively. In further preferred embodiments, the first and second modem data processing unit 141 and 142 stores ensemble channel information of the corresponding frequency band into the memory 150 when the channel information is normal ensemble channel information according to a result of the decision.

Accordingly, in certain preferred embodiments, the conventional DMB receiving unit 120 starts to collect the channel information for the first frequency in the list of total frequencies, and the TPEG-only receiving unit 130 starts to collect the channel information for the second frequency in the list of total frequencies at the same time. Preferably, each of the receiving units 120 and 130 decides, through the lock status check of each of the RF tuners 121 and 131, whether the broadcasting signal is normally received or not, and collects to transmit the FIC data to the A/V decoder 140 if it is decided that the broadcasting signal is normally received.

Preferably, each of first and second modem data processing units 141 and 142 allocated to each of receiving units in the A/V decoder 140, may suitably collect the FIC data for a given period of time. Further, if the FIC data are adequately collected in the given period of time, the first and second modem data processing units 141 and 142 suitably decide whether the FIC data have normal information for the corresponding channel or not, respectively. Accordingly, the first and second modem data processing units 141 and 142 stores the ensemble channel information of the corresponding frequency band into the memory 150 if it is decided that the channel information is the normal ensemble channel information according to the result of decision.

In still further preferred embodiments, when both of the correcting process of information for the corresponding channel and the storing process of the ensemble channel information are suitably completed, the DMB receiving unit 120 and the TPEG-only receiving unit 130 select any one frequency that is not yet dealt in the list of total frequencies, respectively, and perform a channel scan process, respectively. Subsequently, the above-described channel scanning process is programmed to be repeatedly performed up to the final frequency band.

Further, the LCD 160 may suitably output video data of the DMB signal or TPEG broadcasting signal to display, and the speaker 170 may suitably output audio data of the DMB signal or TPEG broadcasting signal.

In further preferred embodiments, according to an embodiment of the present invention, in collecting information for total channels of the DMB system, both of the conventional DMB receiving unit 120 and the TPEG-only receiving unit 130 are used, and, it is possible to suitably reduce the scan time for total channels of the DMB system by simultaneously performing scanning for other channel during a process for collecting the FIC information in relation to scan channels.

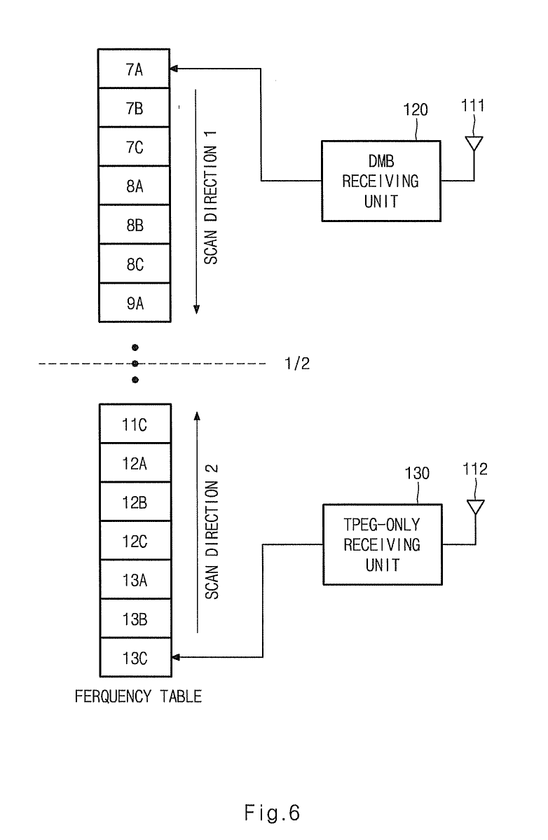

FIG. 6 is a view for explaining a method for reducing scan time of a DMB system according to another preferred embodiment of the present invention.

Referring to FIG. 6, in the DMB system according to an embodiment of the present invention, the frequency auto-scan may suitably perform the frequency scanning by scanning the frequency table simultaneously along each of scan directions allocated by the first and second RF tuner 121 and 131, respectively. In one exemplary embodiment, the first RF tuner 121 performs frequency scanning from “7A” to “9A” along the first scan direction, and the second RF tuner 131 performs frequency scanning simultaneously from “11C” to “13C” along the first scan direction, wherein the scan directions may be in the opposite direction.

Preferably, the frequency table has a frequency list which corresponds to frequencies for the specific country/region broadcasting or the cable television. Further, the DMB system designates an index for adequate frequencies, and calls the methods corresponding to the index so that the specific frequency may be tuned. Preferably, in some country/region, an index number of the frequency table may be directly mapped to a channel number.

According to further preferred embodiments of the present invention, the DMB system performs the channel retrieval process which preferably comprises the steps of: suitably collecting the FIC information in case where the lock status check is performed, suitably analyzing the collected FIC information, and suitably acquiring the normal channel information. The channel retrieval process is repeatedly performed up to the final frequency.

In other further embodiments, a method for reducing scan time in a DMB system including a DMB receiving unit 120 and a TPEG-only receiving unit 130, is described herein. In one exemplary embodiment, the DMB receiving unit 120 starts to collect channel information for a first frequency in a list of total frequencies for a broadcasting signal received through the first antenna 111, and, the TPEG-only receiving unit 130 starts simultaneously to collect channel information for a second frequency for a broadcasting signal received through the second antenna 112.

Preferably, the DMB receiving unit 120 and the TPEG-only receiving unit 130 decide, through a lock status check of the RF tuner 121 and 131, whether a broadcasting signal is suitably received or not, respectively, and collect to transmit the FIC data to an A/V decoder 140 when the broadcasting signal is received.

Preferably, each of first and second modem data processing units 141 and 142 which are allocated to each of receiving units in the A/V decoder 140, collects the FIC data for a given period of time, and decides whether the FIC data have normal information for the corresponding channel or not, respectively.

Preferably, if the FIC data have normal ensemble channel information according to a result of the decision, each of first and second modem data processing units 141 and 142 stores normal ensemble channel information of the corresponding frequency band into the memory 150, respectively.

Preferably, when both of the correcting process of information for the corresponding channel and the storing process of the ensemble channel information are suitably completed, the DMB receiving unit 120 and the TPEG-only receiving unit 130 select any one frequency that are not yet dealt in the list of total frequencies, respectively, and perform a channel scan process, respectively. In further preferred embodiments, the above-described channel scanning process is programmed to be repeatedly performed up to the final frequency band.

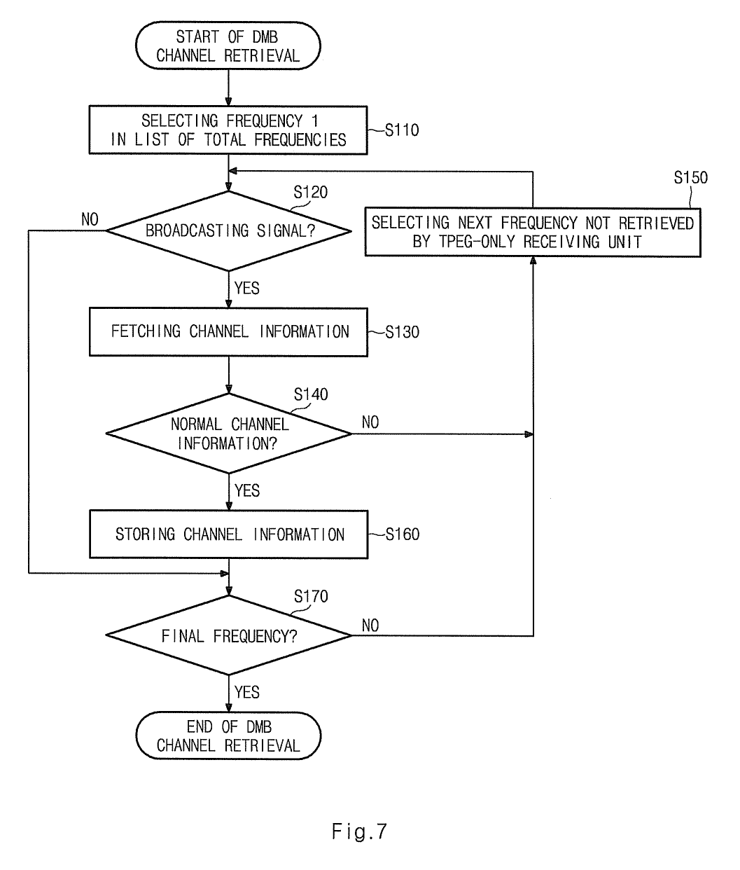

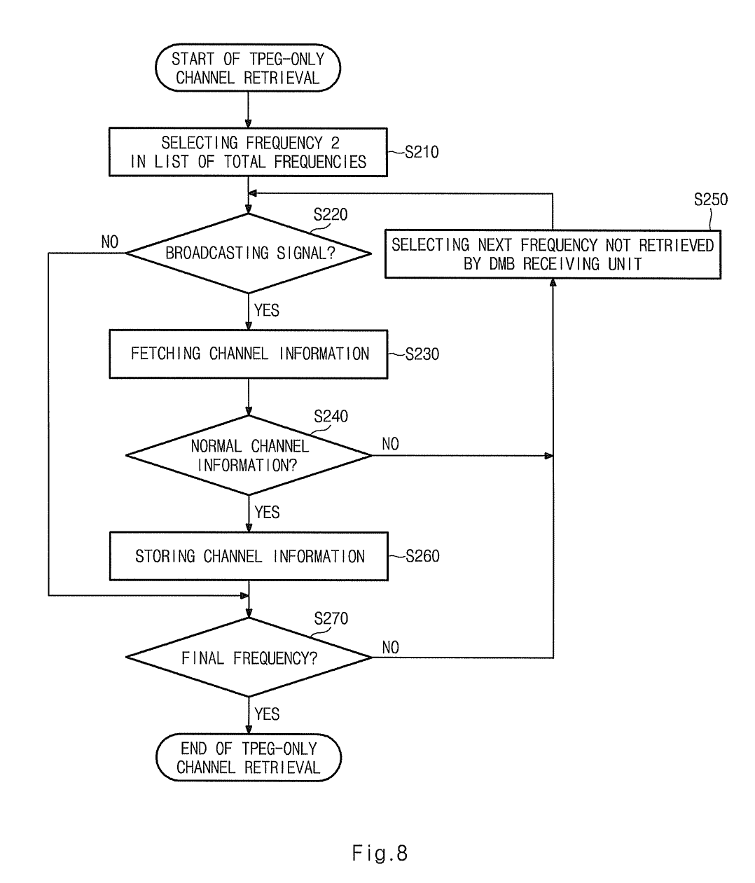

According to preferred exemplary embodiments and as shown in FIGS. 7 and 8, FIG. 7 is a flow chart of a method for reducing scan time by a DMB receiving unit in a DMB system, and FIG. 8 is a flow chart of a method for reducing scan time by a TPEG-only receiving unit in a DMB system.

Preferably, and referring to FIGS. 7 and 8 for example, in the DMB system according to an embodiment of the present invention, when the DMB channel retrieval and the TPEG broadcasting channel retrieval are started, respectively, the DMB receiving unit 120 suitably selects the first frequency in the list of total frequencies S110, and the TPEG-only receiving unit 120 selects the first frequency in the list of total frequencies S210, respectively. Here, the scan directions may be in the reciprocally opposite direction on the frequency table, but they are not limited thereto.

In a further preferred embodiment, the DMB receiving unit 120 decides, through a lock status check of the first RF tuner 121, whether a broadcasting signal is suitably received or not S120, and the TPEG-only receiving unit 130 decides, through a lock status check of the second RF tuner 131, whether a broadcasting signal is suitably received or not S220. Here, if it is decided that the broadcasting signal is suitably received, each of the DMB receiving unit 120 and the TPEG-only receiving unit 130 collects the FIC data, and transmits the FIC data to the A/V decoder 140, respectively.

Preferably, the first modem data processing units 141 of the A/V decoder 140 suitably receives channel information and collects the FIC data for a given period of time S130, and the second modem data processing units 142 of the A/V decoder 140 receives channel information and collects the FIC data for a given period of time S230.

Preferably, the first modem data processing units 141 of the A/V decoder 140 decides whether the FIC data have normal information for the corresponding channel or not S140, and the second modem data processing units 142 of the A/V decoder 140 suitably decides whether the FIC data have normal information for the corresponding channel or not S240.

Preferably, the first modem data processing units 141 of the A/V decoder 140 stores the channel information into the memory 150 if the FIC data have normal channel information S150, and, the second modem data processing units 142 of the A/V decoder 140 stores the channel information into the memory 150 if the FIC data have normal channel information S250.

In another further embodiment, the A/V decoder 140 decides whether the frequency selected in the step of S110 is the final frequency or not S160, and the A/V decoder 140 decides whether the frequency selected in the step of S210 is the final frequency or not S260.

Preferably, in an exemplary embodiment where the channel information is not normal channel information or the selected frequency is not the final frequency, the DMB receiving unit 120 selects next frequency are not yet selected by the TPEG-only receiving unit 130 in the list of total frequencies S170. Further, in an exemplary embodiment where the channel information is not normal channel information or the selected frequency is not the final frequency, the TPEG-only receiving unit 130 suitably selects next frequency that is not yet selected by the DMB receiving unit 120 in the list of total frequencies S270. Preferably, in an example where the selected frequency is the final frequency, the DMB channel retrieval and the TPEG channel retrieval is completed.

According to further preferred embodiments, the above-described channel scanning process is repeatedly performed up to the final frequency band.

According to the DMB system according to preferred embodiments of the present invention, preferably, where the DMB receiving unit and the TPEG-only receiving unit are suitably provided, a lock status check process by the RF tuners or a FIC data collecting process may be suitably performed in parallel using other receiving units at the same time, during the FIC data collecting process using any one receiving unit of the first and second broadcasting receiving units without adding additional cost, in which a relatively long time is required. Accordingly, it is possible to reduce the scan time for total channels.

The foregoing description of the present invention is intended to be illustrative, and those of ordinary skill in the art will understand that the present invention may be changed into other specific forms without modifying technical conceptions or essential characteristics according to the present invention. Therefore, it must be understood that the above-described embodiment is to be illustrative not to be definitive. For example, each of elements described as an integrated element will be embodied in the divided element, and likewise, each of elements described as a divided element will be embodied in the integrated element.

The present invention is intended to fall within the scope of the following appended claims not within the scope of the detailed description, and accordingly, it must be understood that the meaning and scope of the appended claims and all such changes, modifications and variations induced by the equivalents are included in the scope of the present invention.

What is claimed is:

1. A digital multimedia broadcasting (DMB) system for reducing scan time, the DMB system comprising:
a first broadcasting receiving unit for receiving a DMB signal of the first broadcasting data, performing frequency tuning for the DMB signal by each of frequency bands, deciding whether the DMB signal is received or not, through a lock status check, and collecting fast information channel (FIC) data if the DMB signal is received;
a second broadcasting receiving unit for receiving second broadcasting data, performing frequency tuning for a broadcasting signal of the second broadcasting data by each of frequency bands, deciding whether the broadcasting signal is received or not, through a lock status check, and collecting fast information channel (FIC) data if the broadcasting signal is received;
an A/V (Audio/Video) decoder for collecting the FIC data for a given period of time, deciding whether the FIC data have normal information for the corresponding channel or not, and storing ensemble channel information of the corresponding frequency band into a memory when the information is normal ensemble channel information according to a result of the decision,
wherein, the first and second broadcasting receiving units performs frequency tuning for a list of total frequencies in a first scan direction and a second scan direction at the same time.

2. The DMB system of claim 1, wherein the first broadcasting receiving unit is a DMB receiving unit, and the second broadcasting receiving unit is a TPEG (Transport Protocol Expert Group)-only receiving unit.

3. The DMB system of claim 2, wherein second broadcasting data which are received by the TPEG-only receiving unit are TPEG data.

4. The DMB system of claim 1, wherein, during the FIC data collecting process using any one receiving unit of the first and second broadcasting receiving units, in which a relatively long time is required, a lock status check process by the RF tuners or a FIC data collecting process is performed in parallel using other receiving unit at the same time.

5. The DMB system of claim 2, wherein the DMB receiving unit comprises:
a first RF tuner for performing frequency tuning for the DMB signal which is received through a first antenna by each of frequency bands in the first scan direction; and
a first channel decoder for deciding, through the lock status check of the first RF tuner, whether the broadcasting signal is received or not, and for collecting the FIC data if it is decided that the broadcasting signal is received.

6. The DMB system of claim 2, wherein the TPEG-only receiving unit comprises:
a second RF tuner for performing frequency tuning for the TPEG signal which is received through a second antenna by each of frequency bands in the second scan direction; and
a second channel decoder for deciding, through the lock status check of the second RF tuner, whether the broadcasting signal is received or not, and for collecting the FIC data if it is decided that the broadcasting signal is received.

7. The DMB system of claim 1, wherein, when the collecting process of information for the corresponding channel and the storing process of information for an Ensemble channel are completed, the first and second broadcasting receiving units select any one of frequencies which are not yet dealt in the list of total frequencies, and then, perform a channel retrieval scan process, respectively.

8. The DMB system of claim 7, wherein the channel retrieval scanning process is programmed to be repeatedly performed up to the final frequency band.

9. The DMB system of claim 1, wherein the first and second scan directions are in the reciprocally opposite direction on a frequency table.

10. The DMB system of claim 1, wherein the A/V decoder comprises a first modem data processing unit and a second modem data processing unit which are allocated to each of the first and second broadcasting receiving units, wherein the first and second modem data processing units collect the FIC data for a given period of time, respectively, and then, when the FIC data are sufficiently collected in the given period of time, they decide whether the FIC data have normal information for the channel or not.

11. A method for reducing scan time in a DMB system including a first broadcasting receiving unit and a second broadcasting receiving unit, the method comprising the steps of:
a) starting to collect channel information for a first frequency in a list of total frequencies using the first broadcasting receiving unit, and, starting simultaneously to collect channel information for a second frequency using the second broadcasting receiving unit;
b) deciding, through a lock status check of the RF tuner, whether a broadcasting signal is received or not, which is performed by the first and second broadcasting receiving units, respectively, and collecting to transmit the FIC data to an A/V decoder when the broadcasting signal is received;
c) collecting the FIC data for a given period of time, which is performed by each of first and second modem data processing units allocated to each of receiving units in the A/V decoder, and deciding whether the FIC data have normal information for the corresponding channel or not;
d) storing normal ensemble channel information of the corresponding frequency band into a memory if the FIC data have normal ensemble channel information according to a result of the decision; and
e) selecting any one frequency are not yet dealt in the list of total frequencies, which is performed by the first and second broadcasting receiving units, respectively, and performing a channel scan process, when both of the correcting process of information for the corresponding channel and the storing process of the ensemble channel information are completed.

12. The method of claim 11, wherein, in the step of a), the first broadcasting receiving unit is a DMB receiving unit, and the second broadcasting receiving unit is a TPEG (Transport Protocol Expert Group)-only receiving unit.

13. The method of claim 11, wherein the channel scanning process from the step of a) to the step of e) is programmed to be repeatedly performed up to the final frequency band.

14. The method of claim 11, wherein, in the step of a), the first and second broadcasting receiving units performs frequency tuning for the list of total frequencies in a first scan direction and a second scan direction at the same time, in which the first and second scan directions are in the reciprocally opposite direction on a frequency table.

15. The method of claim 11, wherein, in the step of a), during the FIC data collecting process using any one receiving unit of the first and second broadcasting receiving units, in which a relatively long time is required, a lock status check process by the RF tuners or a FIC data collecting process is performed in parallel using other receiving unit at the same time.

16. A digital multimedia broadcasting (DMB) system for reducing scan time, the DMB system comprising:
a first broadcasting receiving unit for receiving a DMB signal of the first broadcasting data;
a second broadcasting receiving unit for receiving a second broadcasting data; and
an A/V (Audio/Video) decoder,
wherein, the first and second broadcasting receiving units performs frequency tuning for a list of total frequencies in a first scan direction and a second scan direction at the same time.

17. The DMB system of claim 16, wherein the first broadcasting unit receives a DMB signal from the first broadcasting data, performs frequency tuning for the DMB signal by each of frequency bands, decides whether the DMB signal is received or not, through a lock status check, and collects fast information channel (FIC) data if the DMB signal is received.

18. The DMB system of claim 16, wherein the second broadcasting receiving unit receives second broadcasting data, performs frequency tuning for a broadcasting signal of the second broadcasting data by each of frequency bands, decides whether the broadcasting signal is received or not, through a lock status check, and collects fast information channel (FIC) data if the broadcasting signal is received.

19. The DMB system of claim 16, wherein the A/V decoder collects the FIC data for a given period of time, decides whether the FIC data has normal information for the corresponding channel or not, and stores ensemble channel information of the corresponding frequency band into a memory when the information is normal ensemble channel information according to a result of the decision.

20. A method for reducing scan time in a DMB system comprising:
a) collecting channel information for a first frequency in a list of total frequencies using a first broadcasting receiving unit;
b) collecting channel information for a second frequency using a second broadcasting receiving unit;
c) deciding, through a lock status check of the RF tuner, whether a broadcasting signal is received or not, and collecting the FIC data to transmit to an A/V decoder when the broadcasting signal is received;
d) collecting the FIC data for a given period of time, which is performed by each of first and second modem data processing units allocated to each of receiving units in the A/V decoder;
e) storing normal ensemble channel information of the corresponding frequency band into a memory; and
f) selecting any one frequency that is not in the list of total frequencies and performing a channel scan process.

21. The method of claim 20, wherein collecting channel information for a first frequency and collecting channel information for a first frequency is performed simultaneously.

22. The method of claim 20, wherein step d) further comprises deciding whether the FIC data have normal information for the corresponding channel.

23. The method of claim 20, wherein in step e) the normal ensemble channel information of the corresponding frequency band s stored into memory if the FIC data have normal ensemble channel information.

24. The method of claim 20, wherein step f) further comprises performing a channel scan process when both of the correcting process of information for the corresponding channel and the storing process of the ensemble channel information are completed.
